(19) United States
(12) Patent Application Publication
(10) Pub. No.: US 2014/0057182 A1
(43) Pub. Date: Feb. 27, 2014

(54) OXYGEN-CARRYING COMPOUNDS IN LI/AIR BATTERIES

(71) Applicants: Lutgard C. DeJonghe, Lafayette, CA (US); Steven J. Visco, Berkeley, CA (US); Yevgeniy S. Nimon, Danville, CA (US); Vitaliy Nimon, San Francisco, CA (US)

(72) Inventors: Lutgard C. DeJonghe, Lafayette, CA (US); Steven J. Visco, Berkeley, CA (US); Yevgeniy S. Nimon, Danville, CA (US); Vitaliy Nimon, San Francisco, CA (US)

(73) Assignee: POLYPLUS BATTERY COMPANY, Berkeley, CA (US)

(21) Appl. No.: 13/289,889

(22) Filed: Nov. 4, 2011

Related U.S. Application Data
(60) Provisional application No. 61/410,628, filed on Nov. 5, 2010.

(51) Int. Cl. H01M 8/22; H01M 8/06

(52) U.S. Cl. 429/405; 429/403; 429/416

(57) ABSTRACT

Active metal oxygen battery cells and active metal oxygen battery flow systems are configurable to achieve very high energy density. The cells and flow systems include an active metal anode and a cathode in contact with an organic liquid phase oxygen-carrying compound for storing and delivering molecular oxygen to the cathode whereon the molecular oxygen is electro-reduced during cell discharge.

### CROSS-REFERENCE TO RELATED APPLICATIONS

This application claims priority to U.S. Provisional Patent Application No. 61/410,628 filed Nov. 5, 2010, titled OXYGEN-CARRYING COMPOUNDS IN LI/AIR BATTERIES, which is incorporated herein by reference in its entirety and for all purposes.

### BACKGROUND OF THE INVENTION

1. Field of the Invention

The present invention relates generally to active metal electrochemical devices, and in particular embodiments to an active metal oxygen battery cell (e.g., a lithium/oxygen cell) having an organic liquid phase oxygen carrying compound that serves to store and/or deliver molecular oxygen to the cathode for electro-reduction during cell discharge.

2. Description of Related Art

In active metal air battery cells, such as Li/Air, the source of molecular oxygen electro-reduced at the cathode during cell discharge is ambient air. In alternative configurations, closed Li/oxygen cells typically make use of a pressurized tank of oxygen wherefrom molecular oxygen is stored and delivered to or passed over the cathode in the form of oxygen gas. Open to air cell configurations, while advantageous from an energy perspective, may be unsuitable for certain use applications and the weight, cost and safety of using pressurized oxygen gas can be prohibitive.

### SUMMARY OF THE INVENTION

In various aspects, the present invention is directed to an active metal oxygen battery cell having an organic liquid phase oxygen carrying compound (OCC) for storing and delivering molecular oxygen to the cathode where the molecular oxygen is electro-reduced during cell discharge. Other aspects of the invention pertain to the operation and use of such cells.

In various embodiments the instant active metal oxygen battery cells have an active metal anode, a cathode for electro-reducing molecular oxygen and an organic liquid phase oxygen carrying compound (OCC) in contact with the cathode and which has a high solubility for molecular oxygen. Preferably the OCC is also substantially immiscible with water and has a high boiling point and a low vapor pressure. Preferably the boiling point is greater and the vapor pressure lower than that of water.

In various embodiments the solubility of the organic liquid phase OCC has a molecular oxygen solubility that is greater than 0.003 mol O₂/mol, preferably greater than 0.004 mol O₂/mol, more preferably greater than 0.005 mol O₂/mol, and even more preferably greater than 0.006 mol O₂/mol. The OCC is used to store and deliver molecular oxygen to the cathode for electro-reduction during cell discharge and as such preferably the volume percent of oxygen dissolved in the OCC is high and typically greater than 10%, preferably greater than 20%, more preferably greater than 30% and even more preferably greater than 40% by volume.

In various embodiments the OCC is a liquid organofluorine compound. Such compounds can be found in blood substitutes, sometimes referred to as artificial blood. In accordance with the present invention, these compounds find use in an entirely different context, for storing and delivering molecular oxygen to the cathode of Li/air battery cells. Suitable classes of OCC compounds for use in the context of the battery cells and methods of the present invention include a fluoroalkane (e.g., linear or cyclical perfluoroalkanes), fluoroalkene, fluorooxolane, fluoroamine, and/or fluoroether.

Particular examples are perfluoro-1-isopropoxy-hexane, perfluoro-1,4-diisopropoxybutane, perfluorotributylamine, perfluorobutylperfluorotetrahydrofuran, bis(perfluorohexyl)ethane, perfluorodecaline, perfluorooctyl bromide, and/or perfluorodichlorooctane.

In other embodiments the OCC may be a liquid siloxane compound (e.g., octamethylcyclotetrasiloxane).

In various embodiments the active metal oxygen battery cell of the instant invention is open to the ambient air (i.e., it is an active metal air battery cell). In various embodiments the cell is configured such that the ambient air interfaces with the cathode and serves as a source of molecular oxygen that is ultimately electro-reduced at the cathode during cell discharge. In various embodiments the cathode of the instant active metal air battery cell includes a first porous body layer, sometimes referred to herein as the outer oxygen supply layer, that, configured in the cell adjacent the ambient air, comprises in its pores one or more of an organic liquid phase OCC, and therein the OCC serves as a storage reservoir for molecular oxygen absorbed directly from the air, the OCC being in contact with the ambient air. In certain embodiments thereof the cathode of the instant cell further comprises a second porous body layer, in pore communication with the first porous body layer, and which serves as an electron transfer medium for electro-reducing molecular oxygen derived from the OCC and which has diffused into its porous channels. Typically the second porous body layer, which is configured nearby the active metal anode, comprises, in its pores, a liquid electrolyte conductive to the active metal ion (e.g., aqueous or non-aqueous) and which supports the ionic current between the active metal anode and the cathode, and may serve as a medium through which molecular oxygen obtained from the OCC diffuses through the porous channels of the second body layer.

Typically the OCC incorporated in the pores of the first porous body layer is hydrophobic and of a relatively high boiling point (e.g., preferably greater than the boiling point of the liquid electrolyte) and thus provides a two way barrier against: i) ingress of moisture from entering the cell and ii) egress of the liquid electrolyte from evaporating out of the cell.

In various alternative embodiments the cell is hermetically sealed from the ambient environment and operated as such, and therefore prior to sealing the OCC is enriched with molecular oxygen to maximize cell capacity. In various sealed cell embodiments the dual porous layer cathode structure as described above may be used and the OCC and liquid electrolyte substantially unmixed, but it is also contemplated that the OCC is intermixed with or otherwise in solution with the liquid electrolyte in contact with the cathode.

In various embodiments the instant active metal oxygen battery is a flow battery system comprising a cell as described in the aforementioned embodiments and further including a storage container comprising a liquid phase OCC enriched with molecular oxygen and remotely positioned from the cell, and in particular the cathode. To deliver the OCC to the cathode, the battery system includes a pump, for pumping, and pipeworks for providing the medium through which the enriched OCC is delivered to the cathode. In certain embodiments the pump and pipe works are configured for circulation in order to deliver oxygen enriched OCC to the cathode and to remove depleted OCC from the cell where it may be replenished, remotely from the cathode, by exposing the OCC to an oxygen-containing environment preferably absent carbon dioxide.

In various embodiments the active metal anode of the aforementioned active metal/oxygen battery cells is an alkali metal, e.g., lithium. In certain embodiments, to improve stability of the alkali metal anode adjacent to the cathode, the alkali metal anode is a protected alkali metal anode having an alkali metal anode layer and an ionically conductive protective membrane architecture on the surface of the anode which provides a barrier against contact between the alkali metal anode layer and one or more of the ambient air, oxygen, liquid electrolyte and OCC present in or nearby the cathode.

In various embodiments the active metal ion conducting liquid electrolyte in contact with the cathode and in certain embodiments in the pores of the cathode second porous body layer is a non-aqueous liquid electrolyte, typically an organic liquid solvent (e.g., propylene carbonate) having a lithium salt dissolved therein. However, the invention is not limited as such and in other embodiments the liquid electrolyte is aqueous, and in such embodiments wherein the active metal anode is of the alkali type it is preferably protected, as described above, in order to improve the stability of the alkali metal anode by preventing its contact with water.

In various aspects the invention provides methods.

In various embodiments the invention provides a method of using an organic liquid phase oxygen carrying compound (OCC) for storing and delivering molecular oxygen to the cathode of an active metal battery cell. The method including the step of providing an active metal oxygen battery cell in accordance with the various embodiments described above and further comprising an organofluorine or siloxane compound or more generally an OCC having a relatively high oxygen solubility in contact with the cathode; for instance, greater than 0.003 mol O₂/mol, preferably greater than 0.004 mol O₂/mol, more preferably greater than 0.005 mol O₂/mol, and even more preferably greater than 0.006 mol O₂/mol.

In various embodiments, the aforementioned method embodiments further include pumping the OCC to the cathode using a pump and pipeworks, and in certain embodiments thereof circulating the OCC nearby the cathode for the dual purpose of i) delivering oxygen enriched OCC to the cathode and ii) removing oxygen depleted OCC away from the cathode, and furthermore, in certain embodiments thereof, replenishing the OCC in an oxygen containing environment that is remote from the cathode and preferably absent carbon dioxide.

These and other features of the instant invention are further described and exemplified in the detailed description below.

### BRIEF DESCRIPTION OF THE DRAWINGS

FIG. 1 illustrates a cross sectional depiction of a battery cell in accordance with various embodiments of the present invention.

FIGS. 2A-B illustrate a cross sectional depiction of a battery cell in accordance with two different embodiments of the present invention.

FIG. 3 illustrates a cross sectional depiction of a flow battery in accordance with various embodiments of the present invention.

FIGS. 4A-D illustrate various alternative configurations of a protected alkali metal electrode structure in accordance with various embodiments of the present invention.

FIG. 5 depicts chemical structures for various compound classes and representative examples of oxygen carry compounds (OCCs) in accordance with embodiments of the present invention.

### DETAILED DESCRIPTION OF SPECIFIC EMBODIMENTS

Reference will now be made in detail to specific embodiments of the invention. Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention. In the following description, numerous specific details are set forth in order to provide a thorough understanding of the present invention. The present invention may be practiced without some or all of these specific details. In other instances, well known process operations have not been described in detail so as to not unnecessarily obscure the present invention.

The present invention provides an alternative active metal oxygen battery cell and in particular is directed to the use of OCCs for storing and delivering molecular oxygen to the cathode of such cells.

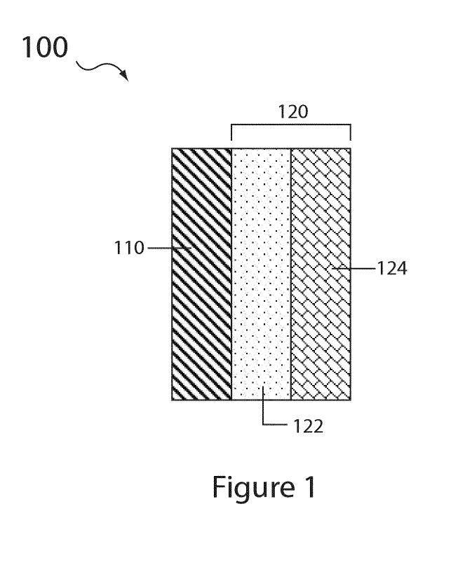

With reference to FIG. 1 there is illustrated an embodiment of an active metal oxygen battery cell 100 in accordance with the instant invention. The cell 100 includes an active metal anode 110 (e.g., a lithium metal foil layer, or a lithium alloy layer (e.g., Li alloy of silicon or tin)) and a cathode architecture 120 having two distinct porous body layers in pore communication with each other. The first porous body layer 124 configured adjacent an edge boundary of the cell and the second porous body layer 122 interposed between the active metal anode 110 and the first porous body layer 122. The first porous body layer contains in its pores an organic liquid phase oxygen carrying compound (OCC) and typically the porous channels of the second layer contain a liquid electrolyte conductive to the active metal anode. The second porous body layer also serves as the electron transfer medium on which molecular oxygen is electro-reduced during cell discharge. A particularly suitable electron transfer medium is a porous carbonaceous layer composed of carbon black held together with a suitable polymeric binder component (e.g., polytetrafluorethylene, polyethylene oxide and polyvinylidience fluoride), and optionally containing on its surface a catalyst to facilitate the oxygen electrode reaction. Suitable reduction catalysts include manganese oxide catalysts and platinum black as catalyst. The first porous body layer may also be carbonaceous and therewith capable of providing electron transfer, but is more typically non-conductive such as a porous polymer layer (e.g., a microporous polyethylene layer).

In accordance with the instant invention, the OCC in the pores of the first porous layer has a high solubility for oxygen. In various embodiments the solubility of the organic liquid phase OCC has a molecular oxygen solubility that is greater than 0.003 mol O₂/mol, preferably greater than 0.004 mol O₂/mol, more preferably greater than 0.005 mol O₂/mol, and even more preferably greater than 0.006 mol O₂/mol.

Various oxygen-carrying compounds (OCCs) are widely used as blood substitutes, sometimes referred to as artificial blood. Typically, these are organic liquids having a high solubility and diffusion coefficient for O₂. Such OCCs can dissolve up to about 40% oxygen by volume, have high boiling points and viscosities, and are immiscible with water. The present invention applies OCCs such as these in an entirely different context, for storing and delivering molecular oxygen to the cathode of Li/air battery cells.

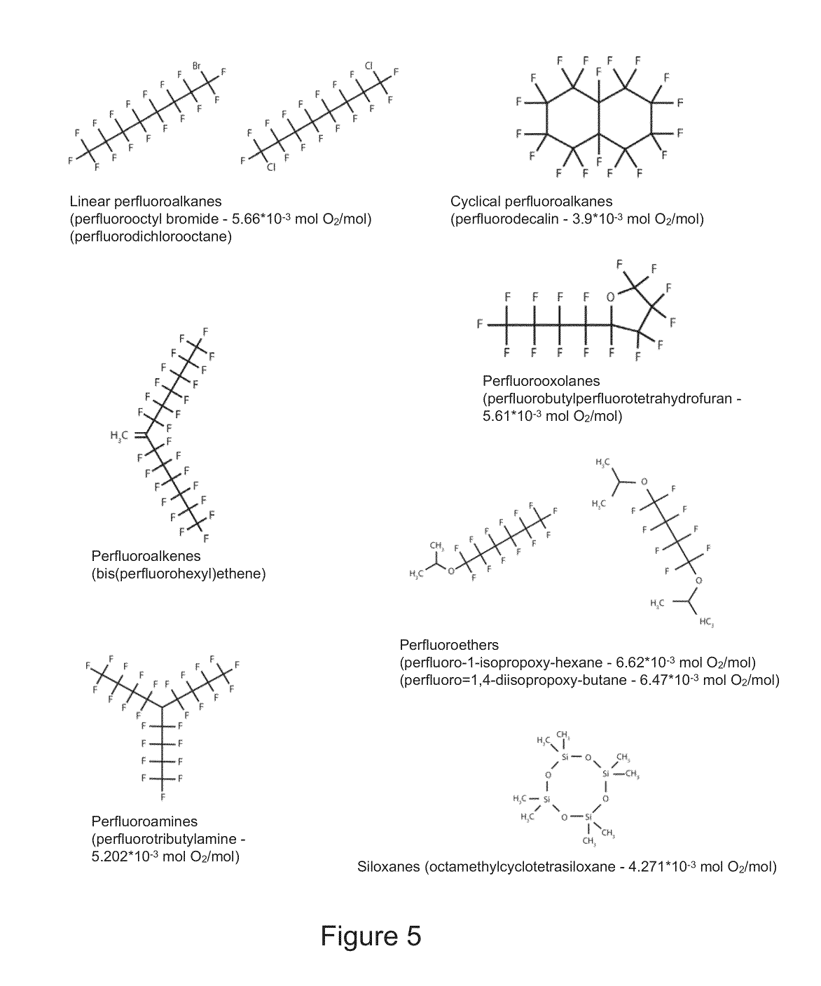

In various embodiments, a suitable OCC in accordance with the present invention is a liquid organofluorine compound. For instance, a suitable OCC may be a fluoroalkane (e.g., linear or cyclical perfluoroalkanes), fluoroalkene, fluorooxolane, fluoroamine, and/or fluoroether. Particular examples are perfluoro-1-isopropoxy-hexane, perfluoro-1,4-diisopropoxybutane, perfluorotributylamine, perfluorobutylperfluorotetrahydrofuran, bis(perfluorohexyl)ethane, perfluorodecaline, perfluorooctyl bromide, and/or perfluorodichlorooctane. In other embodiments, the OCC may be a liquid siloxane compound (e.g., octamethylcyclotetrasiloxane). These OOC compound classes are illustrated and represented by specific examples by the chemical structures depicted in FIG. 5.

In accordance with various embodiments of the instant invention, the OCC in the pores of the first porous body layer is of a sufficiently high boiling point and immiscible with water, such that it is capable of providing a two-way barrier against the ingress of moisture and egress of the liquid electrolyte, e.g., water when the electrolyte is aqueous.

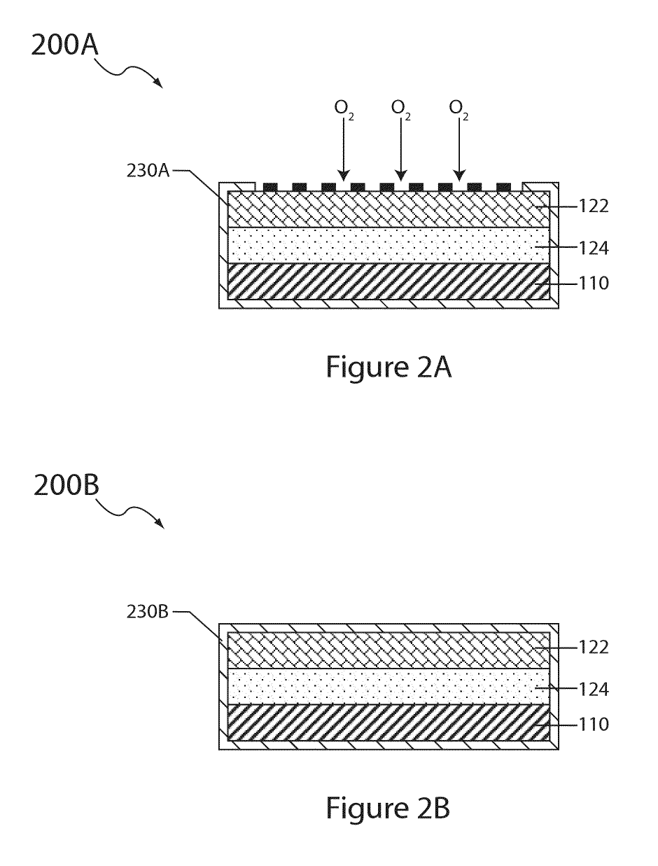

With reference to FIG. 2A in various embodiments the active metal oxygen battery cell 200A of the instant invention is open to the ambient air (i.e., an active metal air battery cell). In such embodiments the air cell 200A is configured such that the ambient air, which is external to the cell, interfaces with the cathode 120, and in particular, for certain embodiments, interfaces with the second porous body layer which provides the outer supply layer and contains in its pores one or more of the various organic liquid phase OCCs embodied above, and therewith the ambient air serves as a source of molecular oxygen that is ultimately electro-reduced at the cathode during cell discharge. The first porous body layer and in particular the OCC contained therein serves as a supply reservoir, which, on the one hand absorbs or getters oxygen from the ambient air and on the other hand releases it to the second porous body layer whereon molecular oxygen is electro-reduced during cell discharge. Typically the second porous body layer contains in its pores a liquid electrolyte which, conductive to the active metal ions, supports the ionic discharge current between the anode and the electron transfer medium of the cathode. The liquid electrolyte contained in the porous channels may also provide a pathway from which the molecular oxygen traverses from the OCC to the electron transfer medium. The cell casing 230A may be made from any suitable material, including casing walls made from polyethylene and the top wall having sufficient openings in its surface to allow for the necessary influx of molecular oxygen from the air into the cathode.

In other embodiments, as illustrated in FIG. 2B, the instant cell 200B may be fully sealed from the ambient air. In such instances the outer supply layer should be sufficiently thick and porous to store all or most of the molecular oxygen to be reacted at the cathode. The casing 230B may be made from any suitable material known in the art including polyethylene or a metal casing such as aluminum or a multi-layer laminate as is known in the lithium ion battery field as a casing component. Preferably the casing 230B provides a hermetic seal about the cell.

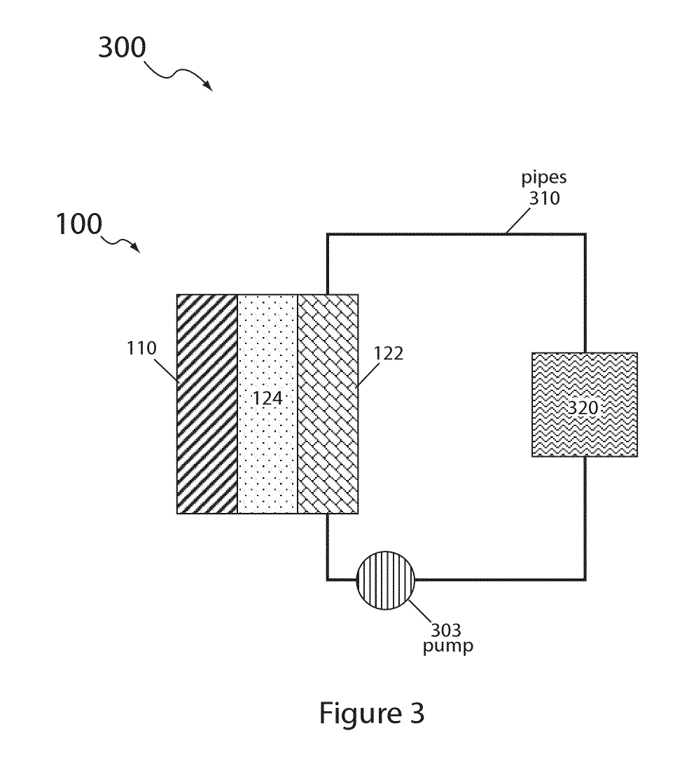

With reference to FIG. 3, in accordance with various embodiments, the battery 300 has a flow cell architecture and includes flow battery components such as a pump 303, storage container 320 (for storing the organic liquid phase OCC) and pipe works 310 for flowing and/or circulating the OCC fluid through the cell 100, and in particular to the cathode 120. Suitable storage containers include those made from metals and metal alloys such as stainless steels but are not limited as such and more preferably the storage container is made from a lightweight metal such as aluminum, or a carbon composite, or even more preferred a plastic material (such as polyethylene) and by this expedient provides tremendous advantage over storing compressed oxygen in a heavy metal tank. Pumps are known in the art and should be capable of flowing the OCC liquid at the desired flow rate, and the pipeworks, like the container, may be made from light weight plastic materials, such as, but not limited to, polyethylene tubing.

The OCC stored in the container is caused to flow via pumping action to the cathode wherefrom molecular oxygen ultimately diffuses to an electron transfer medium whereon it is electro-reduced. The flow of OCC may be continuous or intermittent. For instance, it is contemplated that the OCC may be caused to flow to the cathode and the pumping action ceased until all or most of the oxygen is electro-reduced, and then the pump action turned back on to circulate the depleted oxygen, e.g., back to the storage container or a reservoir (not shown) wherein the OCC is replenished, preferably without contacting carbon dioxide. By this expedient the flowing action of the OCC not only provides molecular oxygen to the cathode it also removes depleted OCC away from the cathode, where it is replenished in the reservoir via oxygen exposure.

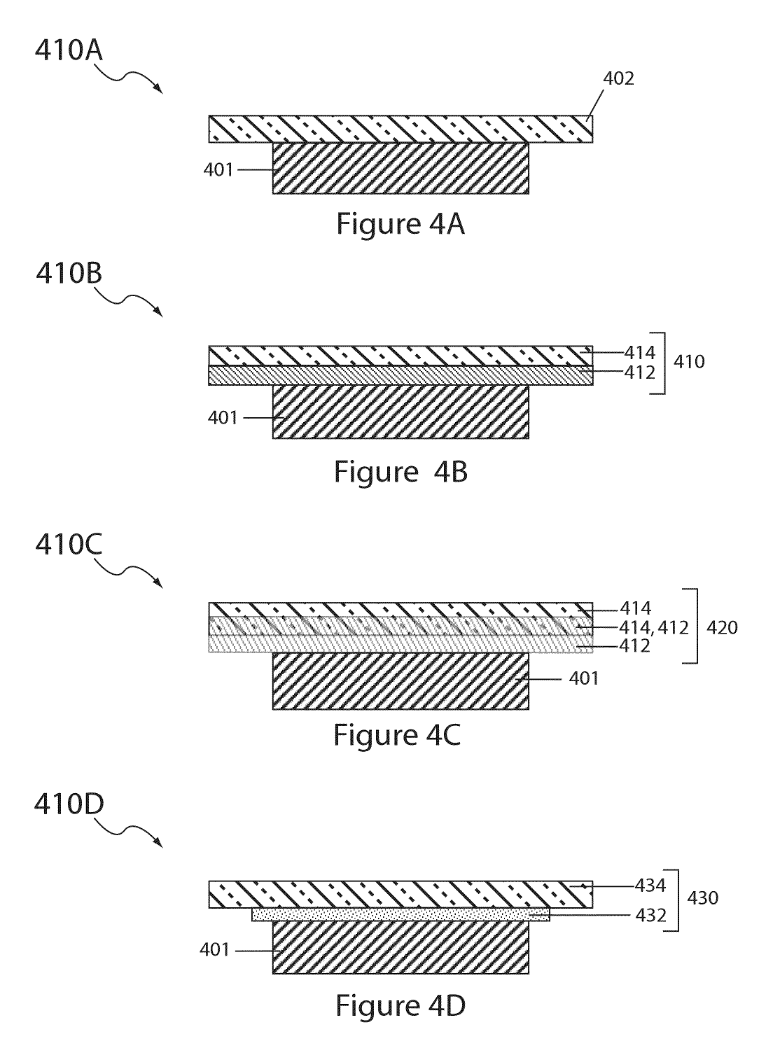

In various embodiments the aforementioned instant cells and flow batteries have an active metal anode that is an alkali metal anode, for instance sodium or lithium, e.g., lithium. Suitable alkali metal anode materials include both lithium and sodium metals, lithium and sodium alloys (e.g., lithium silicon and lithium tin alloys) and lithium and sodium intercalation materials, such as lithiated carbons. In certain embodiments, and especially for those embodiments wherein the liquid electrolyte of the cathode is aqueous, the alkali metal anode 110 is a protected alkali metal anode, e.g., a protected lithium electrode, as illustrated in FIGS. 4A-D.

Continuing with reference to FIGS. 4A-D there is illustrated various embodiments of a protected alkali electrode (e.g., protected lithium electrode) 410A-D having a protective membrane architecture on the surface of the lithium foil or other lithium electroactive layer such as lithium silicon alloy and the like.

Protected alkali metal electrodes and methods of making protected electrodes having both compliant seal and rigid seals, and which are particularly suitable for use herein as a protected alkali metal electrode in the battery cells of the instant invention, are fully described US Patent Application No.: 2007/0037058 and US Patent Application No.: US 2007/0051620 to Visco et al., and are hereby incorporated by reference in their entirety.

As shown in FIGS. 4A-D the protective membrane architecture (402, 410, 420 and 430) is chemically stable to both the electroactive lithium layer and the external environment. The protective membrane architecture typically comprises a solid electrolyte membrane and an interlayer. The protective membrane architecture is in ionic continuity with the active anode layer and is configured to selectively transport Li ions out of the anode enclosure while providing an impervious barrier to the environment external to the anode (e.g., ambient air). Protective membrane architectures suitable for use in the present invention are described in applicants' co-pending published US Applications US 2004/0197641 and US 2005/0175894 and their corresponding International Patent Applications WO 2005/038953 and WO 2005/083829, respectively, incorporated by reference herein.

FIGS. 4A-D illustrate representative protective membrane architectures from these disclosures suitable for use in the present invention. The protective membrane architectures provide a barrier to isolate a Li anode (e.g., lithium foil) from ambient and/or the cathode side of the cell while allowing for efficient ion Li metal ion transport into and out of the anode. The architecture may take on several forms. Generally it comprises a solid electrolyte layer that is substantially impervious, ionically conductive and chemically compatible with the external ambient (e.g., air or water) or the cathode environment.

Referring to FIG. 4A, the protective membrane architecture can be a monolithic solid electrolyte 402 that provides ionic transport and is chemically stable to both the active metal anode 401 and the external environment. Examples of such materials are Na-beta alumina, LiHfPO₄ and NASICON, Nasiglass, Li₅La₃Ta₂O₁₂ and Li₅La₃Nb₂O₁₂. Na₅MSi₄O₁₂ (M: rare earth such as Nd, Dy, Gd).

More commonly, the ion membrane architecture is a composite composed of at least two components of different materials having different chemical compatibility requirements, one chemically compatible with the anode, the other chemically compatible with the exterior; generally ambient air or water, and/or battery electrolytes/catholytes. By “chemical compatibility” (or “chemically compatible”) it is meant that the referenced material does not react to form a product that is deleterious to battery cell operation when contacted with one or more other referenced battery cell components or manufacturing, handling, storage or external environmental conditions. The properties of different ionic conductors are combined in a composite material that has the desired properties of high overall ionic conductivity and chemical stability towards the anode, the cathode and ambient conditions encountered in battery manufacturing. The composite is capable of protecting an active metal anode from deleterious reaction with other battery components or ambient conditions while providing a high level of ionic conductivity to facilitate manufacture and/or enhance performance of a battery cell in which the composite is incorporated.

Referring to FIG. 4B, the protective membrane architecture can be a composite solid electrolyte 410 composed of discrete layers, whereby the first material layer 412 (also sometimes referred to herein as “interlayer”) is stable to the active metal anode 401 and the second material layer 414 is stable to the external environment. Alternatively, referring to FIG. 4C, the protective membrane architecture can be a composite solid electrolyte 420 composed of the same materials, but with a graded transition between the materials rather than discrete layers.

Generally, the solid state composite protective membrane architectures (described with reference to FIGS. 4B and 4C) have a first and second material layer. The first material layer (or first layer material) of the composite is ionically conductive, and chemically compatible with an active metal electrode material. Chemical compatibility in this aspect of the invention refers both to a material that is chemically stable and therefore substantially unreactive when contacted with an active metal electrode material. It may also refer to a material that is chemically stable with air, to facilitate storage and handling, and reactive when contacted with an active metal electrode material to produce a product that is chemically stable against the active metal electrode material and has the desirable ionic conductivity (i.e., a first layer material). Such a reactive material is sometimes referred to as a “precursor” material. The second material layer of the composite is substantially impervious, ionically conductive and chemically compatible with the first material. Additional layers are possible to achieve these aims, or otherwise enhance electrode stability or performance. All layers of the composite have high ionic conductivity, at least 10⁻⁷ S/cm, generally at least 10⁻⁶ S/cm, for example at least 10⁻⁵ S/cm to 10⁻⁴ S/cm, and as high as 10⁻³ S/cm or higher so that the overall ionic conductivity of the multi-layer protective structure is at least 10⁻⁷ S/cm and as high as 10⁻³ S/cm or higher.

A fourth suitable protective membrane architecture is illustrated in FIG. 4D. This architecture is a composite 430 composed of an interlayer 432 between the solid electrolyte 434 and the active metal anode 401 whereby the interlayer is impregnated with anolyte. Thus, the architecture includes an active metal ion conducting separator layer with a non-aqueous anolyte (i.e., electrolyte about the anode), the separator layer being chemically compatible with the active metal and in contact with the anode; and a solid electrolyte layer that is substantially impervious (pinhole- and crack-free) ionically conductive layer chemically compatible with the separator layer and aqueous environments and in contact with the separator layer. The solid electrolyte layer of this architecture (FIG. 4D) generally shares the properties of the second material layer for the composite solid state architectures (FIGS. 4B and C). Accordingly, the solid electrolyte layer of all three of these architectures will be referred to below as a second material layer or second layer.

A wide variety of materials may be used in fabricating protective composites in accordance with the present invention, consistent with the principles described above. For example, in the solid state embodiments of FIGS. 4B and C, the first layer (material component), in contact with the active metal, may be composed, in whole or in part, of active metal nitrides, active metal phosphides, active metal halides active metal sulfides, active metal phosphorous sulfides, or active metal phosphorus oxynitride-based glass. Specific examples include Li₃N, Li₃P, LiI, LiBr, LiCl, LiF, Li₂S—P₂S₅, Li₂S—P₂S₅—LiI and LiPON. Active metal electrode materials (e.g., lithium) may be applied to these materials, or they may be formed in situ by contacting precursors such as metal nitrides, metal phosphides, metal halides, red phosphorus, iodine, nitrogen or phosphorus containing organics and polymers, and the like with lithium. A particularly suitable precursor material is copper nitride (e.g., Cu₃N). The in situ formation of the first layer may result from an incomplete conversion of the precursors to their lithiated analog. Nevertheless, such incomplete conversions (also sometimes referred to as composite reaction products) meet the requirements of a first layer material for a protective composite in accordance with the present invention and in at least some instances have been found to provide performance benefits. These composite reaction products are therefore within the scope of the invention.

For the anolyte interlayer composite protective architecture embodiment (FIG. 4D), the protective membrane architecture has an active metal ion conducting separator layer chemically compatible with the active metal of the anode and in contact with the anode, the separator layer comprising a non-aqueous anolyte, and a substantially impervious, ionically conductive layer (“second” layer) in contact with the separator layer, and chemically compatible with the separator layer and with the exterior of the anode. The separator layer can be composed of a semi-permeable membrane impregnated with an organic anolyte. For example, the semi-permeable membrane may be a micro-porous polymer, such as are available from Celgard, Inc. The organic anolyte may be in the liquid or gel phase. For example, the anolyte may include a solvent selected from the group consisting of organic carbonates, ethers, lactones, sulfones, etc, and combinations thereof, such as EC, PC, DEC, DMC, EMC, 1,2-DME or higher glymes, THF, 2MeTHF, sulfolane, and combinations thereof. 1,3-dioxolane may also be used as an anolyte solvent, particularly but not necessarily when used to enhance the safety of a cell incorporating the structure. When the anolyte is in the gel phase, gelling agents such as polyvinylidine fluoride (PVdF) compounds, hexafluoropropylenevinylidene fluoride copolymers (PVdf-HFP), polyacrylonitrile compounds, cross-linked polyether compounds, polyalkylene oxide compounds, polyethylene oxide compounds, and combinations and the like may be added to gel the solvents. Suitable anolytes will, of course, also include active metal salts, such as, in the case of lithium, for example, LiPF₆, LiBF₄, LiAsF₆, LiSO₃CF₃ or LiN(SO₂C₂F₅)₂. In the case of sodium, suitable anolytes will include active metal salts such as NaClO₄, NaPF₆, NaAsF₆ NaBF₄, NaSO₃CF₃, NaN(CF₃SO₂)₂ or NaN(SO₂C₂F₅)₂, One example of a suitable separator layer is 1 M LiPF₆ dissolved in propylene carbonate and impregnated in a Celgard microporous polymer membrane.

The second layer (material component) of the protective composite may be composed of a material that is substantially impervious, ionically conductive and chemically compatible with the first material or precursor, including glassy or amorphous metal ion conductors, such as a phosphorus-based glass, oxide-based glass, phosphorus-oxynitride-based glass, sulpher-based glass, oxide/sulfide based glass, selenide based glass, gallium based glass, germanium-based glass, Nasiglass; ceramic active metal ion conductors, such as lithium beta-alumina, sodium beta-alumina, Li superionic conductor (LISICON), Na superionic conductor (NASICON), and the like; or glass-ceramic active metal ion conductors. Specific examples include LiPON, Li₃PO₄.Li₂S.SiS₂, Li₂S.GeS₂.Ga₂S₃, Li₂O.11Al₂O₃, Na₂O.11Al₂O₃, (Na,Li)₁₊ₓTi₂₋ₓAlₓ(PO₄)₃ (0.1=x=0.9) and crystallographically related structures, Li₁₋ₓHf₂₋ₓAlₓ(PO₄)₃ (0.1=x=0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-Silicates, Li_{0.3}La_{0.5}TiO₃, Na₅MSi₄O₁₂ (M: rare earth such as Nd, Gd, Dy) Li₅ZrP₃O₁₂, Li₅TiP₃O₁₂, Li₃Fe₂P₃O₁₂ and Li₄NbP₃O₁₂, and combinations thereof, optionally sintered or melted. Suitable ceramic ion active metal ion conductors are described, for example, in U.S. Pat. No. 4,985,317 to Adachi et al., incorporated by reference herein in its entirety and for all purposes.

A particularly suitable glass-ceramic material for the second layer of the protective composite is a lithium ion conductive glass-ceramic having the following composition:

| Composition | mol % |
|---|---|
| P₂O₅ | 26-55% |
| SiO₂ | 0-15% |
| GeO₂ + TiO₂ | 25-50% |
| in which GeO₂ | 0-50% |
| TiO₂ | 0-50% |
| ZrO₂ | 0-10% |
| M₂O₃ | 0-10% |
| Al₂O₃ | 0-15% |
| Ga₂O₃ | 0-15% |
| Li₂O | 3-25% |

and containing a predominant crystalline phase composed of Li₁₊ₓ(M,Al,Ga)ₓ(Ge_{1-y}Ti_{y})₂₋ₓ(PO₄)₃ where X=0.8 and 0=Y=1.0, and where M is an element selected from the group consisting of Nd, Sm, Eu, Gd, Tb, Dy, Ho, Er, Tm and Yb and/or Li_{+x+y}QₓTi₂₋ₓSi_{y}P_{3-y}O₁₂ where 0<X=0.4 and 0<Y=0.6, and where Q is Al or Ga. The glass-ceramics are obtained by melting raw materials to a melt, casting the melt to a glass and subjecting the glass to a heat treatment. Such materials are available from OHARA Corporation, Japan and are further described in U.S. Pat. Nos. 5,702,995, 6,030,909, 6,315,881 and 6,485,622, incorporated herein by reference.

Another particularly suitable material for the second layer of the protective composite is a lithium ion conducting oxide having a garnet like structure. These include Li₆BaLa₂Ta₂O₁₂; Li₇La₃Zr₂O₁₂, Li₅La₃Nb₂O₁₂, Li₅La₃M₂O₁₂ (M=Nb, Ta), Li₇₊ₓZnₓLa₃₋ₓZr₂O₁₂. These materials and similarly functional materials and methods for making them are described in U.S. Patent Application Pub. No.: 2007/0148553 (application Ser. No. 10/591,714) hereby incorporated by reference for its description of these materials, and suitable garnet like structures, are described in International Patent Application Pub. No.: WO 2009/003695 which is hereby incorporated by reference for its description of these materials.

The composite should have an inherently high ionic conductivity. In general, the ionic conductivity of the composite is at least 10⁻⁷ S/cm, generally at least about 10⁻⁶ to 10⁻⁵ S/cm, and may be as high as 10⁻⁴ to 10⁻³ S/cm or higher. The thickness of the first precursor material layer should be enough to prevent contact between the second material layer and adjacent materials or layers, in particular, the active metal of the anode. For example, the first material layer for the solid state membranes can have a thickness of about 0.1 to 5 microns; 0.2 to 1 micron; or about 0.25 micron. Suitable thickness for the anolyte interlayer of the fourth embodiment range from 5 microns to 50 microns, for example a typical thickness of Celgard is 25 microns.

The thickness of the second material layer is preferably about 0.1 to 1000 microns, or, where the ionic conductivity of the second material layer is about 10⁻⁷ S/cm, about 0.25 to 1 micron, or, where the ionic conductivity of the second material layer is between about 10⁻⁴ about 10⁻³ S/cm, about 10 to 1000 microns, preferably between 1 and 500 microns, and more preferably between 10 and 100 microns, for example about 20 microns.

The solid electrolyte membrane defines the exterior surface of the protective membrane architecture, and it may have a homogenous composition or a composition that varies with thickness, for instance a graded or discrete variation (e.g., the solid electrolyte membrane itself a laminate composite of multiple layers, having discrete or gradual interfaces).

The lithium active layer 401 (i.e., anode layer) may be lithium foil or other suitable layer of, e.g., a lithium alloy such as lithium silicon, or lithiated carbon coated on an appropriate current collector (e.g., copper foil).

### CONCLUSION

Although the foregoing invention has been described in some detail for purposes of clarity of understanding, it will be apparent that certain changes and modifications may be practiced within the scope of the invention. While the invention has been described in conjunction with some specific embodiments, it will be understood that it is not intended to limit the invention to such specific embodiments. On the contrary, it is intended to cover alternatives, modifications, and equivalents as may be included within the spirit and scope of the invention as defined by the appended claims.

What is claimed is:

1. A metal oxygen battery cell comprising:
an active metal anode;
a cathode for electro-reducing molecular oxygen; and
a non-aqueous liquid oxygen carrying compound (OCC) in contact with the cathode.

2. The cell of claim 1, wherein the OCC has a molecular oxygen solubility greater than a value selected from the group consisting of 0.003 mol O₂/mol, 0.004 mol O₂/mol, 0.005 mol O₂/mol, and 0.006 mol O₂/mol.

3. The cell of claim 1, wherein the OCC is a liquid organofluorine.

4. The cell of claim 1, wherein said OCC is selected from the group consisting of fluoroalkanes, fluoroalkenes, fluorooxolanes, fluoroamines, fluoroethers, liquid siloxanes, and combinations thereof.

5. The cell of claim 1, wherein said OCC is selected from the group consisting of perfluoro-1-isopropoxy-hexane, perfluoro-1,4-diisopropoxy-butane, perfluorotributylamine, perfluorobutylperfluorotetrahydrofuran, bis(perfluorohexyl)ethane, perfluorodecaline, perfluorooctyl bromide, perfluorodichlorooctane, and combinations thereof.

6. The cell of claim 1, wherein:
i) the cell is open to ambient air;
ii) the cathode interfaces with the ambient air; and
iii) the ambient air serves as a source of molecular oxygen electro-reduced at the cathode during cell discharge.

7. The cell of claim 6, wherein:
i) the cathode comprises:
a first porous body layer comprising in its pores the OCC; and
a second porous body layer that serves as an electron transfer medium for electro-reducing molecular oxygen, and said second porous body layer comprises a liquid electrolyte conductive to said active metal ions;
ii) wherein the relative position of the first and second porous body layers is such that the first layer is closer to the ambient air and the second layer is closer to the active metal anode; and
iii) further wherein the first and second layers are in sufficient pore communication to allow for the inter-diffusion of molecular oxygen between said layers.

8. The cell of claim 7, wherein the OCC is hydrophobic and provides a two way barrier against 1) ingress of moisture from entering the cell and 2) egress of the second layer liquid electrolyte from evaporating out of the cell.

9. The cell of claim 1, wherein the cell is fully sealed from the ambient environment and, prior to sealing, the OCC is enriched with molecular oxygen that, dissolved in the OCC, serves as the major source of cathode capacity.

10. The cell of claim 1, wherein the cell is an active metal oxygen flow battery comprising the cell as described in claim 1, the flow battery further comprising a storage container comprising the liquid oxygen carrying compound enriched with molecular oxygen and a pump that delivers the OCC to the cathode.

11. The cell of claim 10, further configured to circulate said OCC, wherein said circulation provides molecular oxygen to the cathode for electro-reduction during cell discharge and removes depleted OCC.

12. The cell of claim 11, wherein the cell is configured for remote replenishment of oxygen-depleted OCC from the cathode by exposure to an environment comprising molecular oxygen.

13. The cell of claim 12, wherein said replenishing environment does not contain carbon dioxide.

14. The cell of claim 1, wherein the active metal anode is an alkali metal anode.

15. The cell of claim 14, wherein the alkali metal anode is lithium.

16. The cell of claim 15, wherein the alkali metal anode is a protected alkali metal anode.

17. The cell of claim 16, wherein the protected alkali metal anode is a protected lithium electrode.

18. The cell of claim 1, further comprising a liquid electrolyte conductive to the active metal ion and in contact with the active metal anode.

19. The cell of claim 18, wherein the liquid electrolyte is aqueous.

20. The cell of claim 1, further comprising a non-aqueous liquid conductive to the active metal ion and in contact with the active metal anode.

21. A method of using a liquid oxygen carrying compound (OCC) for delivering molecular oxygen to the cathode of an active metal battery cell, said method comprising the steps of:
i) providing an active metal oxygen battery cell comprising an active metal anode and a cathode for electro-reducing molecular oxygen; and
ii) providing a liquid organofluorine or liquid siloxane compound as the molecular oxygen carrying compound in contact with said battery cell cathode.

22. The method of claim 21, wherein the OCC is caused to flow to the cathode, through pumping action, in order to provide molecular oxygen to the cathode during cell discharge.

23. A method of replenishing an oxygen carrying compound (OCC) for use in an active metal oxygen flow cell battery, the method including the steps of circulating the OCC nearby the cathode whereby at least a portion of the molecular oxygen is electro-reduced during cell discharge, and replenishing the partially or fully spent OCC in an oxygen containing environment remote from the cathode.
